(19) United States
(12) Patent Application Publication
(10) Pub. No.: US 2025/0249656 A1
(43) Pub. Date: Aug. 7, 2025

(54) ULTRAHIGH-TEMPERATURE PARTICLE-INCORPORATED COMPOSITE AND METHODS OF MANUFACTURING THEREOF

(71) Applicant: The Boeing Company, Arlington, VA (US)

(72) Inventor: Thomas Karl TSOTSIS, Santa Ana, CA (US)

(73) Assignee: The Boeing Company, Arlington, VA (US)

(21) Appl. No.: 18/433,845

(22) Filed: Feb. 6, 2024

(51) Int. Cl. B32B 5/26; B32B 5/02; B32B 37/06; B32B 37/20; B32B 37/24

(52) U.S. Cl. CPC B32B 5/265; B32B 5/022; B32B 37/06; B32B 37/20; B32B 37/24; B32B 2037/243; B32B 2255/02; B32B 2255/20; B32B 2255/28; B32B 2262/02; B32B 2264/107; B32B 2305/076; B32B 2310/021

(57) ABSTRACT

A prepreg that is embedded with ultrahigh-temperature particles by coating one or more veil carrier with ultrahigh-temperature particles, and then incorporating the one or more of the modified veil layer with one or more fabric layer to form a reinforced fabric for a prepreg to enable the formation of layups with tailored amounts of the ultrahigh-temperature particles that vary through the thickness of the reinforced fabric to enable a functionally graded composite that can withstand ultrahigh temperatures.

### TECHNICAL FIELD

The subject matter described herein relates generally to prepregs and, more particularly, to carbon-carbon and ceramic-matrix composites that include ultrahigh-temperature-capable particles.

### BACKGROUND

Prepregs and preforms are composite materials that incorporate spread fibers that are pre-impregnated by epoxy or other polymeric resins to form a partially-cured polymer matrix. The prepregs and preforms allow for further shaping to occur in more-flexible settings, such as on a flat surface and not necessarily in an industrial assembly. Commercial manufacturing of lightweight mechanical components has been simplified by using prepregs and preforms. These lightweight components have been known to be used in technology areas that encounter high-heat environments, such as an airplane wing, airplane engine component, airplane nose cone, automobile engine components, etc.

Incorporation of ultrahigh-temperature materials into preforms and prepregs using conventional techniques is very difficult. In dry preforms, such particles would be completely filtered out during infusion with a precursor matrix resin. In prepregs, particles would have to be mixed in with the initial matrix resin, which could cause viscosity and tack problems in the fabric.

Therefore, it is highly desirable to have a functionally graded material that is easier to make and use as prepregs, such that the structural property of both the inside and the outside of the final mechanical components are not compromised under high temperature. It is further desirable to provide a highly controllable, tailorable deposition of ultrahigh-temperature materials between plies to provide benefits such as barrier properties, improved thermal capabilities and the like.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

Embodiments and processes for manufacturing ultrahigh-temperature particle-incorporated composites are described herein, including incorporating ultrahigh-temperature particles into a prepreg that would benefit from being thermally stable and functionally graded in structure even under ultrahigh-temperature environments and applications.

An exemplary reinforced fabric for prepregs and preforms comprises: one or more of a modified veil layer comprising a nonwoven veil carrier that is coated with at least one type of ultrahigh-temperature particles; and one or more of a fabric layer. A surface of the modified veil layer abuts a surface of the fabric layer in the reinforced composite.

An exemplary method to manufacture a reinforced fabric for prepregs and preforms comprises: preparing a modified veil layer by coating a nonwoven veil carrier with ultrahigh-temperature particles; layering the modified veil layer onto a surface of a fabric layer; and forming a reinforced fabric.

An exemplary method to manufacture a prepreg comprises: preparing a modified veil layer by coating a nonwoven veil carrier with ultrahigh-temperature particles; layering the modified veil layer onto a surface of a fabric layer; forming a reinforced fabric; heat-treating the reinforced fabric; decompose the nonwoven veil carrier; and embedding the ultrahigh-temperature particles into the fabric layer.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic drawing of a first exemplary apparatus and process to modify/coat a veil in a slurry or solution;

FIG. 2 is a schematic drawing of a second exemplary apparatus and process to modify/coat a veil in a series of solutions;

FIG. 3 is a schematic drawing of an exemplary process to incorporate a modified veil into a fabric;

FIG. 4 is a schematic cross-sectional drawing of a fabric with modified veil incorporated;

FIG. 5A is a schematic drawing of a first step of an exemplary process to incorporate a modified veil into a prepreg;

FIG. 5B is a schematic drawing of a second step of an exemplary process to incorporate a modified veil into a prepreg; and

FIG. 6 is a schematic cross-sectional drawing of a prepreg with modified veil incorporated.

It should be noted that some details of the FIGS. have been simplified and are drawn to facilitate understanding of the present teachings rather than to maintain strict structural accuracy, detail, and scale.

### DETAILED DESCRIPTION

Reference will now be made in detail to the present examples, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary implementations in which the present disclosure can be practiced. These implementations are described in sufficient detail to enable those skilled in the art to practice the present disclosure and it is to be understood that other implementations can be utilized and that changes can be made without departing from the scope of the present disclosure. The following description is, therefore, merely exemplary.

A prepreg provided by the described method that incorporates ultrahigh-temperature particles would have improved thermal capabilities that allow the “inside” surface of the prepreg as well as the “outside” surface of the prepreg to be more structurally equal in thermal resistance. Incorporation of the ultrahigh-temperature particles reduces temperature differences between the “inside” surface and “outside” surface of the prepreg and allows the prepreg to maintain functional structure even under ultrahigh temperatures. The present disclosure allows for highly controllable and tailorable deposition of ultrahigh-temperature materials between plies of composite to provide benefits such as barrier properties (e.g., low permeability), improved thermal capabilities, and the like for performance of high-temperature structures in high-temperature environments.

The particle-incorporated prepreg can be cured to form a stable, handleable fabric that is used for subsequent manufacturing of component parts. Heat treatment is generally preferred after forming the fiber layers into a neat, net-shaped preform by conventional means known in the art. Additionally, the preform or prepreg can subsequently be densified into a composite by a vacuum treatment, etc., to form a fully dense component that is then machined to net shape. For the prepreg systems, the modified veil will decompose in situ during the conversion of the precursor matrix into carbon or ceramic in the heat treatment, leaving behind only the ultrahigh-temperature particles inside the prepreg.

Examples of suitable fabrics include, without limit, woven broad goods, flat braids, warp-knit unidirectional or multiaxial fabrics, weft-insertion-stabilized unidirectional fabrics among others.

In an exemplary method to provide a particle-incorporated prepreg, a lightweight, nonwoven, thermoplastic veil is used as a veil carrier to carry ultrahigh-temperature particles that are suitable for forming ultrahigh-temperature composites. The veil is coated with the ultrahigh-temperature particles, then the modified veil carrier is deposited layer-by-layer between dry fabric layers, or on top of a prepreg fiber/fabric, using well-known automated material-handling equipment, or other specialized equipment. In the process, the modified veil carrier will decompose when the fabric is heat-treated, leaving behind the coating of ultrahigh-temperature particles within the heat-treated fabric. Ultrahigh-temperature particles may be considered those capable of withstanding exposure to 1000° C. or above.

By using a lightweight, thermoplastic, nonwoven veil as a veil carrier for ultrahigh-temperature particles, the particles can be incorporated into the prepregs and preforms using conventional material-handling equipment that are regularly used in the art. The nonwoven veil enables relatively easy handling of the particles for depositing and embedding into a prepreg, and the nonwoven veil provides sufficient open porosity through the laminate thickness that also allows fluids, such as high-char-yield polymeric matrix resins or pre-ceramic polymers, to move through the thickness of the layers, as desired.

Examples material of suitable thermoplastic nonwoven veil include, without limit, polyamide, polyimide, polyamide-imide, polyester, polybutadiene, polyurethane, polypropylene, polyetherimide, polysulfone, polyethersulfone, polyphenylsulfone, polyphenylene sulfide, polyetherketone, polyethertherketone, polyarylamide, polyketone, polyphthalamide, polyphemylether, polybutylene terephthalate, polyethylene terephthalate, or any other suitable material.

An original veil carrier can be a conventional nonwoven veil that is sold commercially, or it can be specifically designed and manufactured with predetermined desired properties, such as by areal weight, filament diameter, percentage area coverage, through-thickness porosity, decomposition temperature, or a combination thereof. The original veil carrier can be pre-treated to activate the filament surfaces to be positively or negatively charged prior to coating the veil with ultrahigh-temperature particles.

Examples of pretreatment include, without limitations, plasma treatment, chemical etching, including acid or base treatments, flame treatment, corona-discharge treatment, surface-graft polymerization, ion-beam treatment, laser treatment, photoinitiated graft polymerization, saponification, aminolysis, reduction, and entrapment of poly (ethylene oxide).

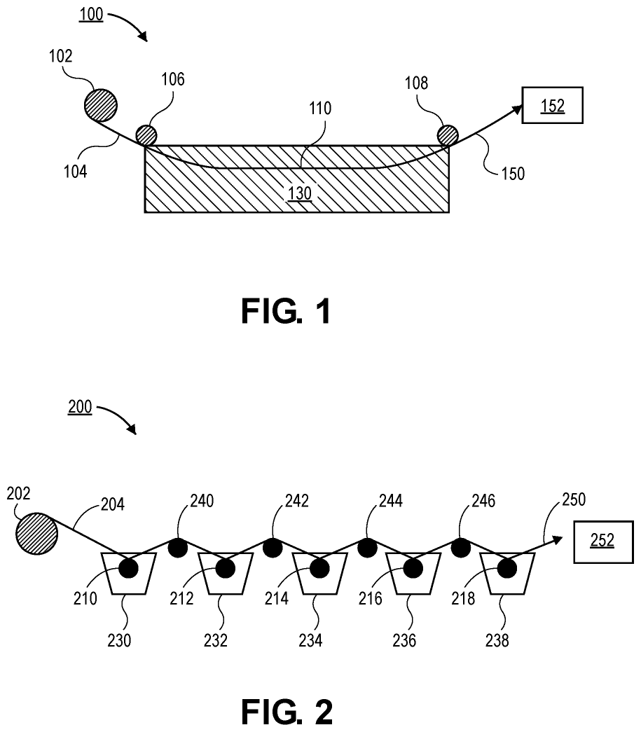

FIG. 1 provides a schematic drawing of a first apparatus and process to modify a veil in a slurry or a liquid solution that modifies the veil in a single-step modification 100. The liquid solution may be aqueous (water-based) or have other liquid chemical base that is capable of allowing a suspension of desired coating materials in the liquid. The coating materials can comprise at least one type of ultrahigh-temperature particles, such as ceramic particles that include titanium carbide particles, hafnium carbide particles, or a combination thereof. Ultrahigh-temperature particles may also include oxides of desired carbides. Oxides may be additionally deposited onto the veil carrier using layer-by-layer deposition, then followed by in situ sintering of the oxides into the carbides through reactions with a polymer veil carrier or other carbonaceous material (e.g. graphene) co-deposited with the oxide. Oxides may be selected, without limit, from vanadium, tungsten, hafnium, titanium, silicon, or other suitable materials.

As shown in FIG. 1, a veil 104 for modification is fed by an input roller 106 to a slurry bath 130. The submerged veil 110 is coated by chemical components that have the desired structurally stabilizing properties, such as a slurry/solution that includes ceramic particles. An exit roller 108 pulls out the modified veil 150 (after coating) out of the slurry 130, and the modified veil 150 is then sent to subsequent processing 152. The veil 104 may have been sent through pre-treatment 102 prior to being fed to the slurry 130 for coating. Examples of slurry compositions include aqueous solutions containing between about 0.5% to about 50% polymer carrier fluid (e.g. polyacrylamide) with between about 0.5% to about 10% nanoparticles (e.g. vanadium oxide).

Pre-treatment 102 may involve processing the veil 104 in solutions to activate the filament surface of the veil 104, and making the filament surfaces positively or negatively charged prior to entering the slurry/solution 130. Subsequent processing 152 of the modified veil 150 may include rinsing baths (such as water baths) and recycling systems of the veil after being coated in the slurry 130, before being sent to form prepregs.

In another embodiment, the process shown in FIG. 1 may be repeated such that the veil is submerged into the same slurry/solution two or more times, such as up to twelve times or more to meet specified thickness targets to coat the veil with ultrahigh-temperature particles. This is known as layer-by-layer deposition, in which a veil is submerged several times in solutions that contain nanoparticles. As described herein and in the literature, layer-by-layer deposition allows for the deposition of monolayers of particles that are oppositely charged from the substrate onto which they are being deposited. Rinsing in between subsequent oppositely charged layers removes any excess material, leaving monolayers. Alternatively, the veil may be repeatedly coated by spraying, dip-coating, roll-to-roll coating, etc., with or without being submerged into a slurry/solution, depending on the substrate and geometry being coated.

In another embodiment, the slurries/solutions in a repeated process may use different slurries/solutions such that each slurry/solution includes different particles to add desired beneficial properties to the veil. The repeated process of submerging the veil may allow the veil to be coated with several layers of desired particles, such as up to twelve or more layers to meet desired thickness targets. The sequence of the slurries/solutions provide specific combination of ultrahigh-temperature particles on the veil, such as the ratio of oxide nanoparticles to polymer or carbonaceous materials within the layers.

FIG. 2 shows a schematic drawing of a second apparatus and a multistep process to modify a veil. The veil 204 may also have been subject to pre-treatment 202 such as described above prior to going through multistep modification 200 shown in FIG. 2. The pre-treatment 202 involves processing the veil 204 in solutions to activate the filament surface of the veil 204, and making the filament surfaces positively or negatively charged prior to entering the multistep modification 200. The pre-treatment 202 may treat the veil 204 using acid or base washes, plasma depositions, dry-etching or wet-etching techniques, or a combination thereof.

In the exemplary multistep modification 200 shown in FIG. 2, the veil 204 is provided with a first coating 210 in a first solution 230, pulled out of the solution by a mechanical roller 240, then the veil 204 enters a first rinse cycle 212 in a first rinse bath 232. The veil 204 is modified again by undergoing a second coating 214 in a second solution 234, a second rinse cycle 216 in a second rinse bath 236, and additionally modified with a third coating 218 in a third solution 238. During each of the step, mechanical rollers (240, 242, 244, 246) may be used to submerge and remove the veil from solutions during the modification process 200. The modified veil 250 may subsequently be sent to further processing 252, such as being incorporated into prepregs.

The first solution 230, the second solution 234, and the third solution 238 have different positive and negative charges between the solutions. The solutions are prepared such that the first solution 230 has an opposite charge from the fiber surface, and each subsequent solution, such as the second solution 234 and the third solution 238, have an opposite charge from the solution immediately prior and immediately following. The coating materials in the solutions can be ceramic particles, such as titanium carbide particles or hafnium carbide particles, other ultrahigh-temperature-capable particles, or a combination thereof. Oxides of desirable carbides may also be deposited using the described layer-by-layer deposition followed by in situ sintering of the oxides into carbides through reactions with a polymer veil carrier or other carbonaceous material (e.g. graphene) co-deposited with the oxide. Oxides may be selected, without limit, from vanadium, tungsten, hafnium, titanium, silicon, or other suitable materials.

The first rinse bath 232 and the second rinse bath 236 can be carrier fluids used in the solution immediately prior to the rinse cycle. For example, the first rinse bath 232 may contain the carrier fluid in the first solution 230, and the second rinse bath 236 may contain the carrier fluid in the second solution 234. The first rinse bath 232 and the second rinse bath 236 are devoid of particles. In an exemplary process, water is used as the aqueous rinse bath. Carrier fluids are generally dilute polyelectrolytes comprising, without limitation, solutions of a polymer such as positively charged poly (allylamine hydrochloride) (PAH), polyethyleneimine (PEI), or poly (diallyldimethylammonium chloride) (PDDA), and negatively charged polyelectrolytes poly (vinyl sulfate) (PVS), poly (acrylic acid) (PAA), or poly (styrene sulfonate) (PSS).

During the first rinse cycle 212 and the second rinse cycle 216, the rinse solutions remove excess particles that did not adhere to the veil 204 during the first coating 210 and the second coating 214. The removed excess particles that were removed in the first rinse bath 232 and the second rinse bath 236 may be subsequently recycled back into the first solution 230 and the second solution 234, respectively.

After either of the single-step modification 100 or the multistep modification 200, the modified veil 150 or 250 may also be dried and subject to other post-process steps prior to being incorporated into a prepreg. The post-process steps may include exposure to heat, exposure to UV light, or other means of modification that allows the modified veil to have additional desirable and useful properties. Post-processing protects the modified veil during further material handling that could potentially cause the layer-by-layer coating to be damaged or removed. The post-processing stabilizes the coating to offset or prevent damage by material handling.

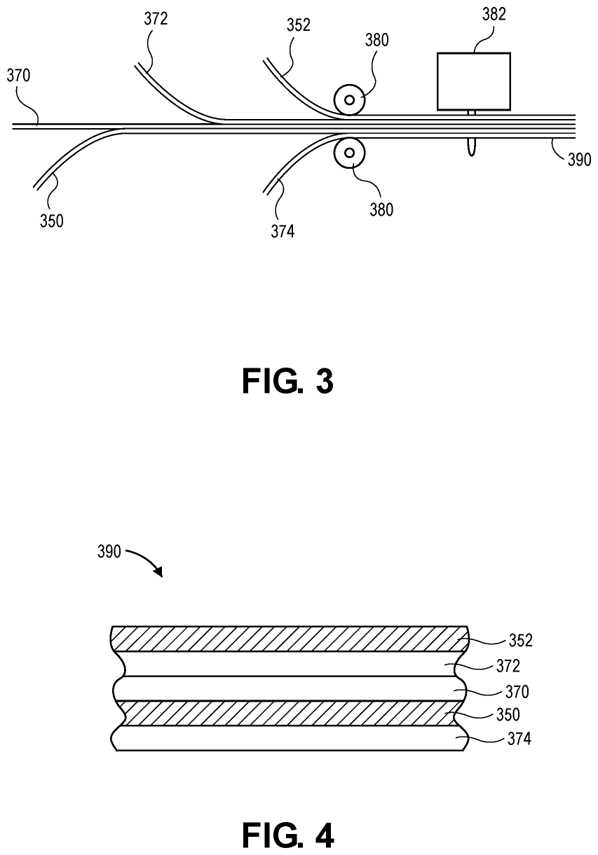

The modified veil 150 of the single-step modification 100 and the modified veil 250 of the multistep modification 200 can be rolled as a fabric or prepreg. FIG. 3 shows a first exemplary method that incorporates a modified veil into a non-crimp fabric.

In FIG. 3, a cross-sectional view of a fabric is shown. A first fibrous layer 370 and a second fibrous layer 372 are provided side-by-side and incorporated as the inner layers of the fabric. A first modified veil layer 350 is provided to abut the first fibrous layer 370 on the opposite surface of the first fibrous layer 370 from the second fibrous layer 372. A second modified veil layer 352 is provided to abut the second fibrous layer 372 on the opposite surface of the second fibrous layer 370 from the first fibrous layer 372. In the fabric in FIG. 3, a third fibrous layer 374 is also provided to abut the first modified veil layer 350 on a surface that is opposite from the first fibrous layer 370. A pair of nip rollers 380 may be used to consolidate the veil layers and fibrous layers together, then the layers are knitted together by using, for example, a knitting station 382, to form a final fabric 390 that incorporates the modified veil layers 350 and 352. Any general type of knitting technique may be used to form the final fabric 390. The final fabric 390 becomes a non-crimp, warp-knit fabric. Alternatively, heat may be used to form a final fabric that incorporates the modified veil layers with the fabric layer. The fabric may be heat treated in an oven or a furnace. The fabric layer may comprise plies of carbon-carbon or ceramic-matrix layers. A cross-sectional view of the final fabric 390 is provided in FIG. 4.

The layering shown in FIGS. 3 and 4 are purely illustrational of the method. There may be additional layers provided to form the fabric, such that additional veil layers and additional fibrous layers are used add to the thickness of the fabric. The fabric may also include additional layers that are not the modified veil and fibrous layers as described. Additional post-processing steps may be used after the final fabric 390 is formed, such as heat treatments, vacuum treatments, and more.

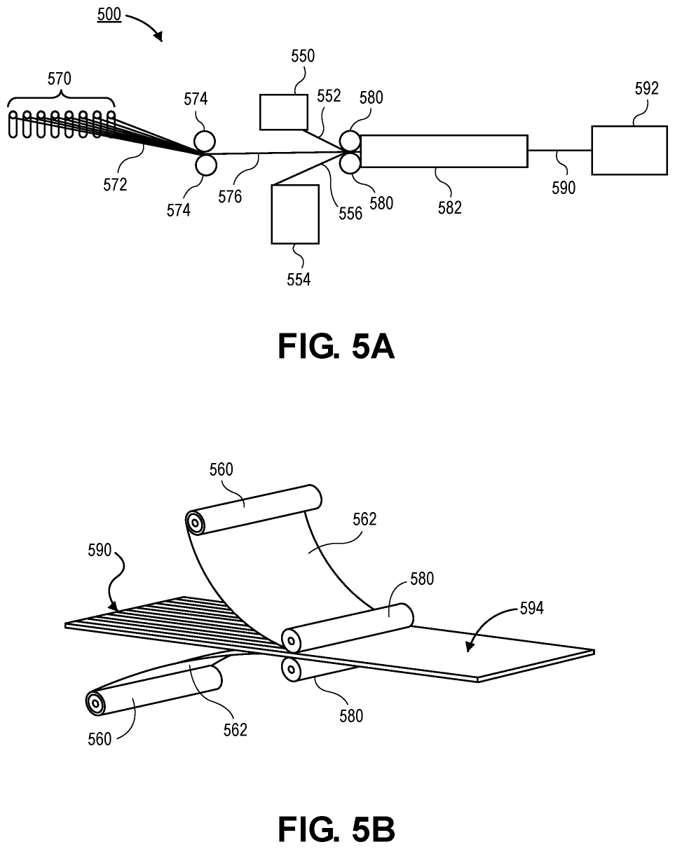

FIGS. 5A and 5B illustrate an exemplary prepreg-manufacturing process 500 to incorporate the modified veil onto fiber into a prepreg such that the prepreg includes both structural fibers and the desired ultrahigh-temperature materials along with the matrix material. The first step is shown in FIG. 5A. One or more fiber creels 570 can provide fibers 572 into the process. The fibers 572 may be spread into spread tows 576 by mechanical components such as spreader bars 574. Alternatively, the fiber creels can be replaced by preformed fabrics to be incorporated with the veil.

The modified veil layers 552 and 556 are provided for prepreg manufacturing 500 after modifications 550 and 554, respectively. Two of the exemplary veil modifications are shown in FIGS. 1 and 2. The modified veil layers 552 and 556 is shown in FIG. 5A to be incorporated on a top and a bottom surface of the spread tows 576, respectively. The modified veil layers 552 and 556 can be joined using mechanical rollers 580, such as being compressed by nip rollers, and the joined layers can be sent through an oven 582 to fuse into a prepreg 590. The heat treatment using an oven 582 (or furnace) may enable melting or tacking of the original veil material and allow the residual chemical particles from the modified veil to be embedded within the prepreg 590. The prepreg 590 could then be sent to further post-treatment, such as further exposure to heat, exposure to UV lights, or other means of modifications that allows the prepreg 590 to have additional desirable and useful properties. In another exemplary method, the modified veil layer can be joined to the spread tows without heat. The prepreg may comprise a layup or preform of plies that includes carbon-carbon or ceramic-matrix.

Additionally, the prepreg 590 can be laminated between two resin-film-coated release papers 562. Conventional resin-film-coated release papers can be used during lamination of the prepreg 590, which may include resin comprising a pre-ceramic polymer or a high-char-yield resin, suitable for conversion to a high-temperature-resistant composite. The resin-film-coated release papers 562 can either be provided from a conventional dispenser 560, or can be specifically prepared for the instant prepreg that incorporates modified veil layers. Using mechanical rollers such as nip rollers 580, the prepreg 590 and the resin-film-coated release papers 562 can be compressed to become a consolidated prepreg 594. The reinforced fabric can be joined with resin-film-coated release papers into a prepreg mechanically without additional heat source. Alternatively, the prepreg can be joined with resin-film-coated release papers into a consolidated prepreg with additional heat, such as sending the consolidated prepreg into an additional oven or furnace after being mechanically compressed together.

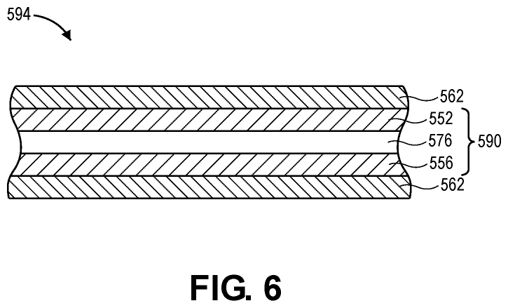

A cross-sectional view of the consolidated prepreg 594 is provided in FIG. 6. The layering shown in FIGS. 5A, 5B, and 6 are purely illustrational of the method. There may be additional layers provided to form the fabric, such that additional veil layers and additional fibrous layers add to the thickness of the fabric. The fabric may also include additional layers that are not the modified veil and fibrous layers as described.

In addition, in the exemplary methods shown in FIGS. 4, 5A and 5B that include heat treatment of the fabric, the original veil material in a preform becomes fugitive such that it is not present in the final fabric after heat treatment. Only the coating particles from the modified veil layer are left in the fabric after the original thermoplastic veil material is completely decomposed during the heat treatment.

A prepreg that incorporates ultrahigh-temperature particles as described can subsequently be used to form a better-quality mechanical component due to having an improved functional structure that can withstand ultrahigh temperatures during application, such as components used for aircraft wings, aircraft nosepiece, car engine, etc. The ultrahigh-temperature particles may provide better thermal stability between the inner surface and outer surface of the prepreg formed component, and thus allows a thermally improved component being made using conventional manufacturing methods to reduce cost.

The veil materials used herein as veil carriers can be comprised of thermoplastic polymers such as such as positively charged poly (allylamine hydrochloride) (PAH), polyethyleneimine (PEI), or poly (diallyldimethylammonium chloride) (PDDA) and negatively charged polyelectrolytes poly (vinyl sulfate) (PVS), poly (acrylic acid) (PAA), or poly (styrene sulfonate) (PSS). Veil morphologies are selected to have between about 5% and about 90% open porosity through the thickness to allow for matrix material to flow and fill-in any spaces between the coated veil filaments.

The particles used to coat the fibers can be taken from any desired class of high-aspect-ratio ceramic nanoparticles, including and not limited to oxides of W, V, Ti, and Hf, carbides of Si, Ta, Ti, Zr, Hf, V, Nb, Cr, Mo, and W, nitrides of Si, Ti, Sc, Y, Fe, Zn, Ag, S, Tl, Al, Ga, In, Be, Mg, Ca, Sr, K, Lim, Na, and B, among others. The composites into which the coated layers may be introduced may include C/SiC, SiC/SiC, C/C, oxide/oxide (e.g. alumina and/or mullite), among others.

The thickness of the modified veil layer (i.e. the veil carrier with the ultrahigh-temperature particles incorporated) may be between about 1 μm and about 100 μm, preferably between about 10 μm and about 75 μm, and most preferably between about 25 μm and about 50 μm.

Ultrahigh-temperature particles incorporated into a veil carrier may be nanoparticles selected from ceramics having aspect ratios between about 2.5 and about 250, preferably between about 20 and about 100 with in-plane dimensions preferably between about 2 nm and about 100 μm and more preferably between about 2 nm and about 100 nm, and most preferably between about 2 nm and about 5 nm.

Preferably, depositions are carried out at ambient temperature and pressure using aqueous solutions with water being used as the rinse agent. The composition of the coating solutions may be between about 0.1% and about 50% nanoparticles, more preferably between about 0.1% and about 10%, and most preferably between about 0.1% and about 1.0%. The number of deposition cycles will be determined by the thickness needed to meet the performance target of interest, which will be highly dependent on the end application.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A reinforced fabric for prepregs, comprising:
one or more of a modified veil layer that comprises a nonwoven veil carrier coated with ultrahigh-temperature particles; and
one or more of a fabric layer abutting a surface of the modified veil layer to form a reinforced fabric that is configured to be incorporated into a prepreg.

2. The reinforced fabric of claim 1, wherein the ultrahigh-temperature particles comprise ceramic particles.

3. The reinforced fabric of claim 2, wherein the ceramic particles are selected from the group consisting of titanium carbide particles, hafnium carbide particles, and a combination thereof.

4. The reinforced fabric of claim 1, wherein the nonwoven veil carrier comprises a thermoplastic nonwoven veil.

5. The reinforced fabric of claim 1, wherein the modified veil layer is provided in between first and second fabric layers, and further wherein one surface of the modified veil layer abuts a first fabric layer, and a second surface of the modified veil layer abuts a second fabric layer.

6. The reinforced fabric of claim 1, wherein the modified veil layer includes two or more coatings comprising ultrahigh-temperature particles.

7. A method to manufacture a reinforced fabric for prepregs, comprising:
preparing a modified veil layer by coating a nonwoven veil carrier with ultrahigh-temperature particles;
layering the modified veil layer onto a surface of a fabric layer; and
forming a reinforced fabric that is configured to be incorporated into a prepreg.

8. The method of claim 7, wherein preparing the modified veil layer includes submerging the nonwoven veil carrier into a coating solution comprising the ultrahigh-temperature particles and a carrier fluid.

9. The method of claim 7, wherein the ultrahigh-temperature particles comprise ceramic particles.

10. The method of claim 9, wherein the ceramic particles comprise titanium carbide particles, hafnium carbide particles, or a combination thereof.

11. The method of claim 7, wherein preparing the modified veil layer includes pretreating the nonwoven veil carrier to impart a positive or negative charge onto the nonwoven veil carrier.

12. The method of claim 7, wherein preparing the modified veil layer further comprises submerging the nonwoven veil carrier in more than one coating solutions and rinsing the nonwoven veil carrier in at least one rinse bath in between submerging the nonwoven veil carrier in each of the more than one coating solutions.

13. The method of claim 12, wherein the at least one rinse bath is comprised of the same carrier fluid as the coating solution immediately prior to the at least one rinse bath.

14. The method of claim 7, further comprising mechanically compressing the modified veil layer with the fabric layer to form the reinforced fabric.

15. The method of claim 7, further comprising heat-treating the reinforced fabric using an oven.

16. A method to manufacture a prepreg, comprising:
preparing a modified veil layer by coating a nonwoven veil carrier with ultrahigh-temperature particles;
layering the modified veil layer onto a surface of a fabric layer;
forming a reinforced fabric;
heat-treating the reinforced fabric;
decompose the nonwoven veil carrier; and
embedding the ultrahigh-temperature particles into the fabric layer.

17. The method of claim 16, wherein the reinforced fabric is heated using an oven.

18. The method of claim 16, wherein the ultrahigh-temperature particles comprise ceramic particles.

19. The method of claim 16, wherein preparing the modified veil layer further comprises submerging the nonwoven veil carrier into a coating solution with the ultrahigh-temperature particles.

20. The method of claim 16, wherein preparing the modified veil layer further comprises submerging the nonwoven veil carrier in more than one coating solutions and rinsing the nonwoven veil carrier in at least one rinse bath in between submerging the nonwoven veil carrier in each of the more than one coating solutions.
